(19) United States
(12) Patent Application Publication
(10) Pub. No.: US 2023/0268790 A1
(43) Pub. Date: Aug. 24, 2023

(54) Stator, Rotary Electric Machine, Electric Wheel, and Vehicle

(71) Applicant: Hitachi, Ltd., Chiyoda-ku, Tokyo (JP)

(72) Inventors: Makoto ITO, Tokyo (JP); Tetsuya SUTO, Tokyo (JP); Akeshi TAKAHASHI, Tokyo (JP)

(21) Appl. No.: 18/020,206

(22) PCT Filed: May 25, 2021
(86) PCT No.: PCT/JP2021/019870

§ 371 Date: Feb. 7, 2023

(30) Foreign Application Priority Data
Sep. 4, 2020 (JP) 2020-149420

(51) Int. Cl. H02K 3/28; H02K 3/12

(52) U.S. Cl. CPC H02K 3/28; H02K 3/12

(57) ABSTRACT

A rotary electric machine (100) comprising, in order to increase a torque density, a stator (101) and a rotor (102) provided so as to be rotatable about the axial center (C), wherein: phase coils (120G) each having a substantially rectangular coil-cross-section are arranged in a row in the radial direction in a slot (110) so as to constitute a plurality of layers; the phase coils (120G) are each wound over a group of three or more slots (110) which are contiguously arranged in the circumferential direction; identical-phase slots (111) are provided on each of which only a combination of phase coils (120G) of an identical phase are arranged; different-phase slots (112) are provided on each of which only a combination of phase coils (120G) of two different phases are arranged; and the different-phase slots (112) are disposed one by one so as to be adjacent to respective two sides of sets of identical-phase slots (111) comprising at least two slots arranged contiguously in the circumferential direction.

### TECHNICAL FIELD

The present invention relates to a stator, a rotary electric machine, an electric wheel, and a vehicle.

### BACKGROUND ART

With the progress of electrification of vehicles and the like, there is an increasing demand for miniaturization and weight reduction of rotary electric machines. Therefore, improvement of torque density of a rotary electric machine has been further demanded. The torque density of the rotary electric machine is represented by the quotient of a torque of the rotary electric machine and a mass of the rotary electric machine. That is, it is essential to achieve high torque of the rotary electric machine and to reduce the weight of the rotary electric machine. In general, there are two winding methods of a rotary electric machine: concentrated winding and distributed winding. Comparing both, it is said that the concentrated winding is suitable for weight reduction because weight of a coil end can be reduced.

That is, the key is to further improve a winding coefficient of the concentrated winding suitable for weight reduction. As a technique capable of improving torque in the case of concentrated winding, a concentrated winding/fractional slot structure is known. This concentrated winding/fractional slot structure is characterized by having a structure in which coils of the same phase are continuously disposed in the circumferential direction.

When this concentrated winding/fractional slot structure is adopted to further improve the torque density of the rotary electric machine, heat generation from the coil becomes a new problem. This is because, in order to achieve high torque density, the stator slot of the miniaturized rotary electric machine becomes narrow, an electric resistance of the coil increases, and heat generation from the coil increases eventually.

Therefore, in order to increase the torque density together with the weight reduction of the rotary electric machine, it is necessary to reduce the electric resistance of the coil. Therefore, it is desirable that a space factor of the coil accommodated in the slot of the stator be high.

A typical coil winding structure of concentrated winding is a structure in which one coil is wound around one tooth. Conventionally, it has been known to use a square wire as one of means for improving the space factor by the concentrated winding. For example, PTL 1 discloses a structure in which a bendable protrusion extending in a radial direction is provided at a tip of a tooth of a stator, a coil is housed in the stator tooth, and then the protrusion located at the tip of the tooth is deformed and bent in a circumferential direction. This structure allows the coil to be wound independently before being incorporated into the stator. By this method, the coils can be finished in a densely wound state and then incorporated into the stator. Therefore, ease of manufacturing the coil is improved, and the coil space factor can be improved.

### CITATION LIST

### Patent Literature

PTL 1: Japanese Patent No. 5537964

### SUMMARY OF INVENTION

### Technical Problem

However, in the stator manufactured with the deformation of the core as in Patent Literature 1, magnetic characteristics in a deformation portion deteriorate. Since a torque decreases and a core iron loss increases as the magnetic characteristics deteriorate, the effect of increasing the coil space factor is offset. While the effect of reducing the copper loss can be obtained by improving the coil space factor, an additional current is required in order to compensate for the torque reduced by the deterioration of the magnetic characteristics. This is because a copper loss increases and the core iron loss also increases as described above. For this reason, there is a concern that the effect of reducing the initially targeted copper loss is canceled. In addition, in the conventional winding structure in which one coil is wound around one tooth, the following problems occur in the slot, and thus it is difficult to improve the space factor.

One is that since different coils are arranged in the circumferential direction in the same slot, a gap is generated between the coils. Usually, a winding nozzle is used when winding a concentrated winding coil. Therefore, a clearance gap through which a tip of the winding nozzle passes is required in the slot. In the method in which the coils are independently wound and then inserted into the stator as in Patent Literature 1 described above, the gap between the coils can be reduced.

However, when a bobbin is used to improve the assemblability of the coil and the coil is wound around the bobbin, the space factor of the coil decreases by a volume of the bobbin. Alternatively, when the bobbin is not used, assemblability of the coil is deteriorated. Therefore, it is necessary to secure a gap for preventing contact with other coils in a step of inserting the coils into the teeth. For this reason, in any of the conventional techniques, considering mass production of the stator by automation, there is a problem that a gap is provided between the coils or a bobbin is required, and the space factor of the coils is reduced accordingly.

Second, in order to insulate coils of different phases from each other, additional insulation is required between the coils. The stator usually includes coils of three phases (U phase, V phase, W phase), and phases of current and an applied voltage are different in each phase. In the stator slot, there are a slot (hereinafter, referred to as an in-phase slot) in which only coils of the same phase enter and a slot (hereinafter, referred to as an out-of-phase slot) in which coils of different phases enter together.

A large potential difference is generated between out-of-phase coils in the out-of-phase slots. Therefore, an insulation design of the coil is determined by insulation performance in the out-of-phase slot. In the concentrated winding structure of the related art, since the out-of-phase coils in the out-of-phase slots are arranged in the circumferential direction, thick insulation is required in the circumferential direction. In the insulation method of the related art, a method of sandwiching an insulator such as insulation paper between out-of-phase coils, a method of thickening an insulating film of a coil, a method of securing a sufficient space distance, or the like is generally used.

When the insulation paper is sandwiched between the out-of-phase coils having a high voltage difference, a gap for inserting the insulation paper is further required in addition to the thickness of the insulation paper. In addition, when the insulating film of the coil is thickened, the total thickness of the insulating film of the coil increases. Therefore, insulation between the coil and the teeth of the stator and the thickness of the insulating film in the radial direction of the rotary electric machine also increase. Therefore, in order to obtain a sufficient insulation property in the out-of-phase slot, a space of the slot is used for insulation or a gap in the circumferential direction of the rotary electric machine, and thus, there is a problem that a space factor of the coil decreases.

An object of the present invention is to eliminate an unnecessary gap between phase coils in a slot. Further, even in the out-of-phase slot, the insulation in the circumferential direction is minimized. Another object of the present invention is to improve a coil space factor of a rotary electric machine and improve a torque density of the rotary electric machine.

### Solution to Problem

In order to solve the above problem, according to an aspect of present invention, there is provided a rotary electric machine including: a stator core having a plurality of slots in a circumferential direction; a stator including at least two or more phase coils each including a conductor slot portion disposed in each of the slots, a conductor crossover portion connecting the conductor slot portion at a coil end, and a lead-out portion; and a rotor rotatably disposed facing a slot opening portion of the stator, in which the phase coil is wound over a group of three or more slots arranged continuously in the circumferential direction, the slot is either an in-phase slot including one of the phase coils therein or an out-of-phase slot including two of the phase coils having different phases, the conductor slot portions are arranged in a line in a radial direction in the slot to form a plurality of layers, and a total number of the layers in all the slots is the same, and (1) one out-of-phase slot is disposed on each of both sides of one in-phase slot disposed in the circumferential direction, or (2) one out-of-phase slot is disposed on each of both sides of two or more in-phase slots continuously arranged in the circumferential direction, and the phase coil has a substantially rectangular cross-sectional shape.

### Advantageous Effects of Invention

In the present invention, there is no unnecessary gap between the phase coils in the circumferential direction. In addition, in the out-of-phase slot, since the out-of-phase coils are arranged only in the radial direction of the rotary electric machine, an insulation paper or a gap for obtaining insulation property in the circumferential direction becomes unnecessary. Furthermore, even when an insulating film is thickened in order to obtain insulation property between the plurality of out-of-phase coils, a volume of an insulator in the circumferential direction can be, for example, about half of the concentrated winding of the related art. Therefore, the space factor of the coil can be improved as compared with the related art. In addition, the layout of the phase coils can be simplified.

### BRIEF DESCRIPTION OF DRAWINGS

FIG. 1 is a cross-sectional view of a rotary electric machine including an inner-rotor-type rotor according to a first embodiment.

FIG. 2 is a cross-sectional view of a rotary electric machine including an outer-rotor-type rotor according to a modification of the first embodiment.

FIG. 3 is a partial cross-sectional view of a stator slot of the rotary electric machine according to the first embodiment.

FIG. 4A is a partial connection diagram of a stator of the rotary electric machine according to the first embodiment (4 layers with 1 in-phase slot, interleaved phase coils in out-of-phase slots).

FIG. 4B is a partial connection diagram of the stator of the rotary electric machine according to a modification (a lead-out wire extraction direction is set to be opposite to the first embodiment) of the first embodiment.

FIG. 5A is a partial connection diagram of a stator of a rotary electric machine according to a modification (four layers and two consecutive in-phase slots) of the first embodiment.

FIG. 5B is a partial connection diagram of a stator of a rotary electric machine according to a modification (three layers and two consecutive in-phase slots, phase coils in out-of-phase slots are arranged alternately) of the first embodiment.

FIG. 5C is a partial connection diagram of a stator of a rotary electric machine according to a modification (four layers, two consecutive in-phase slots, and continuous phase coils in out-of-phase slots) of the first embodiment.

FIG. 5D is a partial connection diagram of a stator of a rotary electric machine according to a modification (two layers and two consecutive in-phase slots) of the first embodiment.

FIG. 5E is a conceptual explanatory diagram of a current flowing through a coil of an out-of-phase slot according to a modification of the first embodiment and a magnetic flux generated thereby.

FIG. 5F is a conceptual explanatory diagram of a current flowing through a coil of an out-of-phase slot according to a modification of the first embodiment and a magnetic flux generated thereby.

FIG. 6 is a partial cross-sectional view of a stator slot of a rotary electric machine of the related art.

FIG. 7 is a partial cross-sectional view of a stator of a rotary electric machine including a split stator according to a second embodiment.

FIG. 8 is a partial cross-sectional view of the split stator according to the second embodiment.

FIG. 9 is a partial connection diagram of a stator of a rotary electric machine according to a third embodiment.

FIG. 10 is a partial cross-sectional view of a stator of a rotary electric machine according to the third embodiment and a modification of the present invention.

FIG. 11A is a partially enlarged view of a coil of a rotary electric machine according to the third embodiment.

FIG. 11B is a partially enlarged view of a coil of a rotary electric machine according to a modification of the third embodiment.

FIG. 12A is a plan view before folding a coil punched out and formed from a thin plate according to the third embodiment.

FIG. 12B is a plan view illustrating a state in which the coil punched out and formed from the thin plate according to the third embodiment is folded once.

FIG. 12C is a plan view illustrating a state in which a coil punched out and formed from the thin plate according to the third embodiment is folded twice.

FIG. 13 is a partial connection diagram of a stator of a rotary electric machine according to a modification of the third embodiment.

FIG. 14A is a partially enlarged view of a coil of a rotary electric machine according to a modification of the third embodiment having a folded portion.

FIG. 14B is a partially enlarged view of a coil of a rotary electric machine according to a modification of the third embodiment having a connecting portion.

FIG. 15 is a plan view of a coil punched out and formed the thin plate and before being folded according to a modification of the third embodiment.

FIG. 16 is a conceptual diagram of a cross section of an electric wheel according to a fourth embodiment.

FIG. 17 is a conceptual diagram of a railway vehicle according to a fifth embodiment.

### DESCRIPTION OF EMBODIMENTS

Hereinafter, the present invention will be described in detail with reference to the drawings. The present invention is not limited to the specific aspects of the following embodiments.

A stator of the present embodiment is intended exclusively for concentrated windings with fractional slots. The fractional slot refers to a slot in which the number of slots for each pole and each phase is a fraction. That is, the ratio of the number N of slots of the stator to the number Q of phases of the stator and the number P of poles of the stator is not an integer. That is, the number of slots per pole is N/ (Q • P) = k + (n/m) (k, n, and m are integers, and (n/m) is a divisor). At this time, the number of in-phase slots per phase coil is n-1. Therefore, the sum of the number of in-phase slots per stator is N • (n-1) /n.

For example, when the number of poles is less than 50, the combination of the number of poles and the number of slots of the stator and the number (illustrated in parentheses) of in-phase slots per phase coil is 8:9(2), 8:9(2), 10:9(2), 10:12(1), 14:12(1), 14:15(4), 14:18(2), 16:15(4), 16:18(2)16:21(6), 20:18(2), 20:21(6), 20:24(1), 20:27(8), 22:18(2), 22:21(6), 22:24(3), 22:27(8), 22:30(4), 24:27(2), 26:21(6), 26:24(3), 26:27(8), 26:30(4), 26:33(10), 26:36(5), 28:24(1), 28:27(8), 28:30(4), 28:33(10), 28:36(2), 28:39(12), 30:27(2), 30:36(1), 32:27(8), 32:30(4), 32:33(10), 32:36(2), 32:39(12), 32:42(6), 32:45(14), 34:27(8), 34:30(4), 34:33(10), 34:36(5), 34:39(12), 34:42(6), 34:45(14), 34:48(7), 38:30(4), 38:33(10), 38:36(5), 38:39(12), 38:42(6), 38:45(14), 38:48(7), 38:51(16), 38:54(8), 40:33(10), 40:36(2), 40:39(12), 40:42(6), 40:45(2), 40:48(1), 40:51(16), 40:54(8), 40:57(18), 42:36(1), 42:45(4), 42:54(2), 44:36(2), 44:39(12), 44:42(6), 44:45(14), 44:48(3), 44:51(16), 44:54(8), 44:57(18), 44:60(4), 44:63(20), 46:36(5), 46:39(12), 46: 42 (6), 46:45(14), 46:48(7), 46:51(16), 46: 54 (8), 46:57(18), 46:60(9), 46:63(20), 46:66(10), 48:45(4), 48:54(2), and 48:63(6).

The combination when the number of poles is 50 to 70 is 50:39(12), 50:42(6), 50:45(2), 50:48(7), 50:51(16), 50:54(8), 50:57(18), 50:60(1), 50:63(20), 50:66(10), 50:69(22), 50:72(11), 52:42 (6), 52:54(14), 52:48(3), 52:51(16), 52:54(8), 52:57(18), 52:60(4), 52:63(20), 52:66(10), 52:69(22), 52:72(5), 52:75(24), 56:45(14), 56:48(1), 56:51(16), 56:54(8), 56:57(18), 56:60(4), 56:63(2), 56:66(10), 56:69(22), 56:72(2), 56:75(24), 56:78(12), 56:81(26), 58:45(14), 58:48(7), 58:51(16), 58:54(8), 58:57(18), 58:60(9), 58:63(20), 58:66(10), 58:69(22), 58:72(11), 58:75(24), 58:78(12), 58:81(26), 58:84(13), 60:54(2), 60:63(6), 60:72(1), 60:81(8), 62:48(7), 62:51(16), 62:54(8), 62:57(18), 62:60(9), 62:63(20), 62:66(10), 62:69(22), 62:72(11), 62:75(24), 62:78(12), 62:81(26), 62:84(13), 62:87(28), 62:90(14), 64:51(16), 64:54(8), 64:57(18), 64:60(4), 64:63(20), 64:66(10), 64:69(22), 64:72(2), 64:75(24), 64:78(12), 64:81(26), 64:84(6), 64:87(28), 64:90(14), 64:93: (30), 66:54(2), 66:63(6), 66:72(3), 66:81(8), 66:90(4), 68:54(8), 68:57(18), 68:60(4), 68:63(20), 68:66(10), 68:69(22), 68:72(5), 68:75(24), 68:78(12), 68:81(26), 68:84(6), 68:87(28), 68:90(14), 68:93(30), 68:96(7), and 68:99(32).

The combination when the number of poles is less than 70 to 80 is 70:54 (8), 70:57 (18), 70:60(1), 70:63(2), 70:66(10), and 70:69(22). 70:72(11),70:75(4),70:78(12),70:81(26),70:84(1), 70:87(28), 70:90(2), 70:93(30), 70:96(15), 70:99(32), 70:102(16), 72:81(2), 74:57(18), 74:60(9), 74:63(20), 74:66(10), 74:69(22), 74:72(11), 74:75(24)74:78(12), 74:81(26), 74:84(13), 74:87(28), 74:90(14), 74:93 (30), 74:96(15), 74:99(32), 74:102(16), 74:105(34), 74:108(17), 76:60(4), 76:63(20), 76:66(10), 76:69(22), 76:72(5), 76:75(24), 76:78(12), 76:81(26), 76:84 (6), 76:87(28), 76:90(14), 76:93(30), 76:96(7), 76:99(32), 76:102(16), 76:105(34), 76:108(8), 76:111(36), 78:63(6), 78:72(3), 78:81(8), 78:90(4), 78:99(10), and 78:108(5).

The combination when the number of poles is less than 80 to 90 and the number of slots is 120 or less is 80:63(20), 80:66(10), 80:69(22), 80:72(2), 80:75(4), 80:78(12), 80:81(26), 80:84(6), 80:87(28), 80:90(2), 80:93(30), 80:96(1), 80:99(32), 80:102(16), 80:105(6), 80:108(8), 80:111(36), 80:114 (18), 80:117(38), 82:63(20), 82:66(10), 82:69(22), 82:72(11), 82:75(24), 82:78(12), 82:81(26), 82:84(13), 82:87(28), 82:90(14), 82:93(30), 82:96(15), 82:99(32), 82:102(16), 82:105(34), 82:108(17), 82:111(36), 82:114 (18), 82:117(38),82:120(19), 84:72(1), 84:81(8), 84:90(4), 84:99(10), 84:108(2), 84:117(12), 86:66(10), 86:69(22), 86:72(11), 86: 75(24) :86: 78(12), 86:81(26), 86:84(13), 86:87(28), 86:90(14), 86:93(30), 86:96(15), 86:99(32), 86:102(16), 86:105(34), 86:108(17), 86:111(36), 86:114(18), 86:117(38), 86:120(19), 88:69(22), 88:72(2), 88:75(24), 88:78(12), 88:81(26), 88:84(6), 88:87(28), 88:90(14), 88:93(30), 88:96(3), 88:99(2), 88:102(16), 88:105(34), 88:108(8), 88:111(36), 88:114(18), 88:117(38), and 88:120(4).

The combination when the number of poles is less than 90 to 100 and the number of slots is 120 or less is 90:81(2), 90:108(1), 92:72(5), 92:75(24), 92:78(12), 92:81(26), 92:84(6), 92:87(28), 92:90(14), 92:93(30), 92:96(7), 92:99(32), 92:102(16), 92:105(34), 92:108(8), 92:111(36), 92:114(18), 92:117(38), 92:120(9), 94:72(11), 94:75(24), 94:78(12), 94:81(26), 94:84(13), 94:87(28), 94:90(14), 94:93(30), 94:96(15), 94:99(32), 94:102(16), 94:105(34), 94:108(17), 94:111(36), 94:114(18), 94:117(38), 94:120(19), 96:81(8), 96:90(4), 96:99(10), 96:108(2), 96:117(12), 98:75(24), 98:78(12), 98:81(26), 98:84(1), 98:87(28), 98:90(14), 98:93(30), 98:96(15), 98:99(32), 98:102(16), 98:105(4), 98:108(17), 98:111(36), 98:114(18), 98:117(38), and 98:120(19).

The combination when the number of poles is less than 100 to 110 and the number of slots is 120 or less is 100:78(12), 100:81(26), 100:84(6), 100:87(28), 100:90(2), 100:93(30), 100:96(7), 100:99(32), 100:102(16), 100:105(6), 100:108(8), 100:111(36), 100:114(18), 100:117(38), 100:120(1), 102:81(8), 102:90(4), 102:99(10), 102:108(5), 102:117(12), 104:81(26), 104:84(6), 104:87(28), 104:90(14), 104:93(30), 104:96(3), 104:99(32), 104:102(16), 104:105(34), 104:108(8), 104:111(36), 104:114(18), 104:117(2), 104:120(4), 106:81(26), 106:84(13), 106:87(28), 106:90(14), 106:93(30), 106:96(15), 106:99(32), 106:102(16), 106:105(34), 106:108(17), 106:111(36), 106:114(18), 106:117(38), and 106:120(19).

The combination when the number of poles is 110 to 120 or less and the number of slots is 120 or less is 110:84(13), 110:87(28), 110:90(2), 110:93(30), 110:96(15), 110:99(2), 110:102(16), 110:105(6), 110:108(17), 110:111(36), 110:114(18), 110:117(38), 110:120(3), 112:87(28), 112:90(14), 112:93(30), 112:96(1), 112:99(32), 112:102(16), 112:105(4), 112:108(8), 112:111(36), 112:114(18), 112:117(38), 112:120(4), 114:90(4), 114:99(10), 114:108(5), 114:117(12), 116:90(14), 116:93(30), 116:96(7), 116:99(32), 116:102(16), 116:105(34), 116:108(8), 116:111(36), 116:114(18), 116:117(38), 116:120(9), 118:90(14), 118:93(30), 118:96(15), 118:99(32), 118:102(16), 118:105(34), 118:108(17), 118:111(36), 118:114(18), 118:117(38), 118:120(19), 120:99(10), 120:108(2), and 120:117(12). The present invention can be applied to a specific combination of the number of poles and the number of slots described above. In addition, even in a case where the number of poles or the number of slots exceeds 120, the present invention can be applied to a combination in which the number of in-phase slots per one phase coil is one or more among combinations obtained from the above mathematical expressions.

### First Embodiment

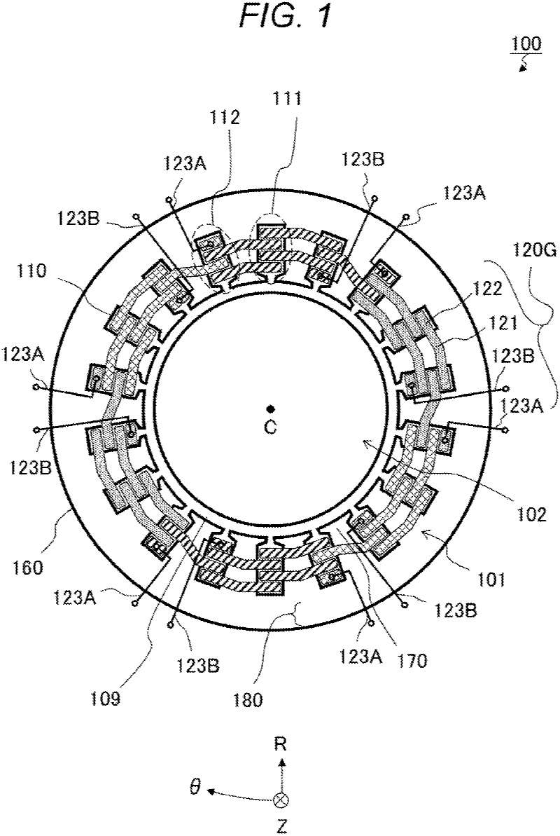

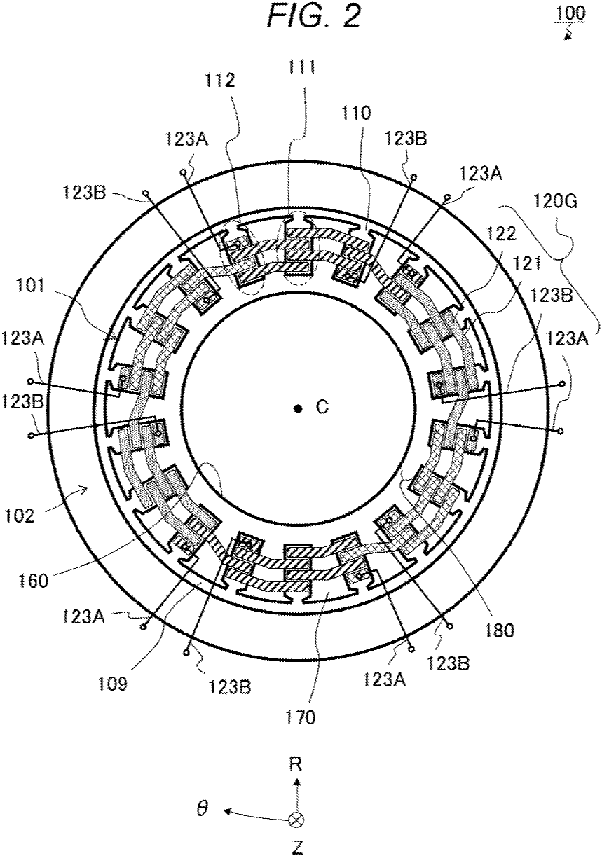

FIG. 1 is a cross-sectional view of a rotary electric machine according to a first embodiment. FIG. 2 is a cross-sectional view of a rotary electric machine according to a modification of the first embodiment of the present invention. The rotary electric machine 100 includes a stator 101 and a rotor 102 rotatably supported with respect to the stator 101. The rotor 102 rotates about a rotation axis C. Hereinafter, unless otherwise specified, in the terms such as an “inner peripheral side” and an “outer peripheral side”, a side closer to the rotation axis C is defined as the “inner peripheral side”, and a side farther from the rotation axis C is defined as the “outer peripheral side”.

A “radial direction R” is defined as a linear direction perpendicular to the rotation axis C, and a “circumferential direction θ” is defined as a rotation direction around the rotation axis C. An “axial direction Z” is defined as a linear direction parallel to the rotation axis C. A shaft (not illustrated) may be fixed to the rotor 102, and the rotary electric machine 100 may include a frame (not illustrated) that covers the stator 101 and the rotor 102.

The rotor 102 is connected to a load (not illustrated) via a structural member such as a shaft or a frame, or directly connected thereto. Rotation and torque are transmitted to the load by rotation of the rotor 102. The stator 101 and the rotor 102 have the same central axis (rotation axis C), and a gap 109 is provided between the stator 101 and the rotor 102 and is disposed so as not to contact each other.

In the rotary electric machine 100, the rotor 102 may be rotatably supported by an inner peripheral side of the stator 101, and the rotor 102 may be rotatably supported by an outer peripheral side of the stator 101. FIG. 1 illustrates a configuration in a so-called inner rotor structure in which the rotor 102 is rotatably supported by the inner peripheral side of the stator 101, and FIG. 2 illustrates a configuration in a so-called outer rotor structure in which the rotor 102 is rotatably supported by the outer peripheral side of the stator 101. The following description is applicable to both the inner rotor structure and the outer rotor structure.

The rotor 102 includes a rotor core (not illustrated) formed by stacking a plurality of electromagnetic steel sheets, and a magnetic pole portion (not illustrated). The rotor core may be formed of an integrally molded solid member. In addition, a powder magnetic body such as a powder magnetic core may be compression-molded, or may be made of an amorphous metal or a nanocrystalline material. The magnetic pole portion is made of, for example, an electric conductor of a rotor bar and an end ring. As a material of the rotor bar and the end ring, for example, copper, aluminum, or the like is used. The end ring may employ any connection method as long as the end ring electrically connects the plurality of rotor bars.

For example, the rotor bar and the end ring may be integrally molded, or may be formed as separate members and connected by a method such as brazing. Although the rotor structure of the squirrel cage induction motor has been exemplified as the structure of the magnetic pole portion, a structure utilizing saliency of the rotor core, for example, a magnetic pole portion of a switched reluctance motor or a synchronous reluctance motor may be used. In addition, any configuration of a magnetic pole portion of a surface magnet type motor or an interior magnet type motor in which at least one permanent magnet (not illustrated) is disposed in the magnetic pole portion, and a magnetic pole portion of a winding field synchronous motor having a field winding (not illustrated) may be adopted.

The stator 101 includes a stator core 160 formed by stacking a plurality of electromagnetic steel sheets, and a plurality of phase coils 120G wound around teeth 170. For example, in the case of winding a three-phase multiphase coil, phase coils of a U phase, a V phase, and a W phase are provided. Basically, phases of the phases are disposed to be shifted by 120°. However, for example, a rotary electric machine having 24 poles and 27 slots is not limited thereto. Further, six phase coils such as a U₁ phase, a U₂ phase, a V₁ phase, a V₂ phase, a W₁ phase, and a W₂ phase may be formed, and the slot positions and the phases thereof may be combined. In this case, a pair of the U₁ phase and the U₂ phase is connected in series or in parallel, and a pair of the V₁ phase and the V₂ phase and a pair of the W₁ phase and the W₂ phase are connected in the same manner as the pair of the U phase. Further, 3a phase coils, such as a U₁ phase, a U₂ phase, ..., a Uₐ phase, a V₁ phase, a V₂ phase, ..., a Vₐ phase, a W₁ phase, a W₂ phase, ..., and a Wₐ phase may be formed, the slot positions and the phases thereof may be combined.

The stator core 160 includes an annular back yoke 180, a plurality of teeth 170 provided on a radial gap 109 side, and slots 110 provided between the teeth 170. The back yoke 180 is connected to the teeth 170. One phase coil 120G is wound around the teeth 170. The stator core 160 may be formed of an integrally molded solid member. In addition, a powder magnetic body such as a powder magnetic core may be compression-molded, or may be made of an amorphous metal or a nanocrystalline material.

The phase coil 120G includes a conductor slot portion 122 disposed in the slot 110 and a conductor crossover portion 121 across the coil end between the slots 110 at different positions. Further, the phase coil 120G includes a lead-out portion 123 (including lead-out wires 123A and 123B) for inputting a current from an external circuit (not illustrated) and connecting the phase coils 120G at different positions. The plurality of phase coils 120G include coils having three phases different from each other as described above in order to generate a rotating magnetic field in the gap 109. The phase coils 120G corresponding to these three phases are arranged to be shifted by, for example, 120° with respect to the circumferential direction of the stator 101. Phase of current fundamental wave components input to the phase coils 120G are different from each other by 120°, so that the rotating magnetic field is generated in the gap 109 to rotate the rotor 102. Although the three-phase coil has been described as an example here, the effect of the present invention can be obtained even in a case where two or more phase coils 120G having at least different phases, such as a five-phase coil, are provided.

A conductor of the phase coil 120G is a square wire having a substantially rectangular cross section. In the present invention, the phase coil 120G is wound over a group of three or more slots arranged continuously in the circumferential direction. At that time, current directions of the plurality of conductor slot portions passing through the same slot coincide with each other. Further, the coils in one slot 110 are arranged in a line only in the radial direction. First, description will be given focusing on one slot 110.

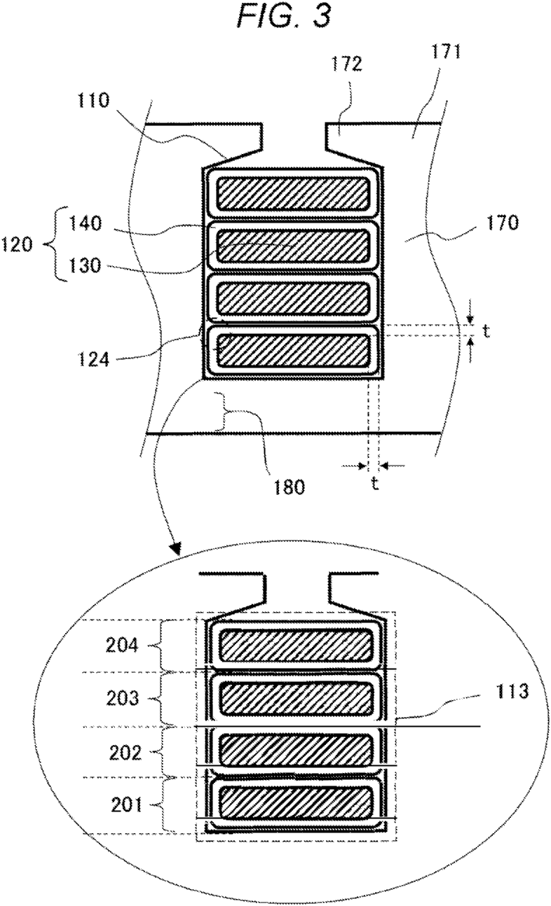

FIG. 3 is a partial cross-sectional view of a slot provided in the stator of the rotary electric machine according to the first embodiment. As illustrated in the drawing, a coil insertion region 113 of the slot 110 preferably has a substantially rectangular shape. In FIG. 3, an overhanging portion 172 is provided at a tee stop 171 of the teeth 170. Therefore, the coil insertion region 113 is a region surrounded by the two adjacent teeth 170, the overhanging portions 172 of the teeth, and the back yoke 180 (see a partially enlarged view of FIG. 3).

When viewed as a single material, the coil 120 includes an element wire 130 for flowing a current and an insulating film 140 for electrically insulating the element wire 130 from surrounding members. As illustrated in FIG. 3, the cross section of the coil 120 including the insulating film 140 is substantially rectangular, and the coils 120 are arranged in the radial direction R (see FIG. 1) in the slots 110 and are not in contact with each other in the circumferential direction θ (see FIG. 1). In the configuration example illustrated in FIG. 3, the plurality of coils 120 constitute four layers of a first layer 201, a second layer 202, a third layer 203, and a fourth layer 204 in a line in the slot 110.

A corner portion 124 of the coil 120 is not necessarily at a right angle, and may be chamfered such as an R surface or a C surface. In particular, the element wire 130 may be chamfered on an R surface, a C surface, or the like in order to alleviate electric field concentration. The material of the element wire 130 is a good conductor, and for example, a material such as copper or aluminum is preferable.

In addition, the insulating film 140 is preferably made of a material having excellent electrical insulation properties, for example, a material such as enamel. However, the material used for the coil is not limited to the specific material described above. In particular, as long as the insulating film 140 has a function of electrical insulation between the element wires 130 or between the element wires 130 and a material such as the stator core 160, it does not need to be a film fixed to the element wires 130, and for example, an insulation tape or an insulation paper may be substituted.

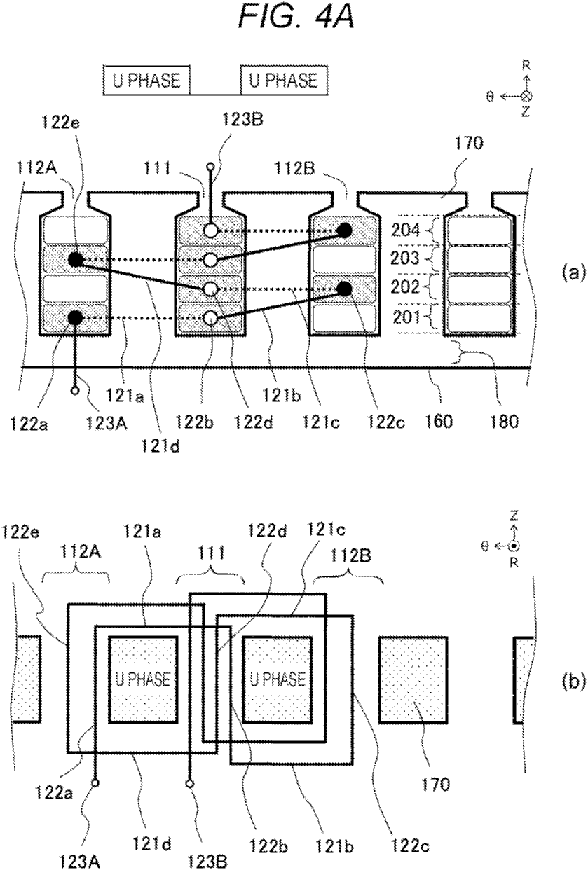

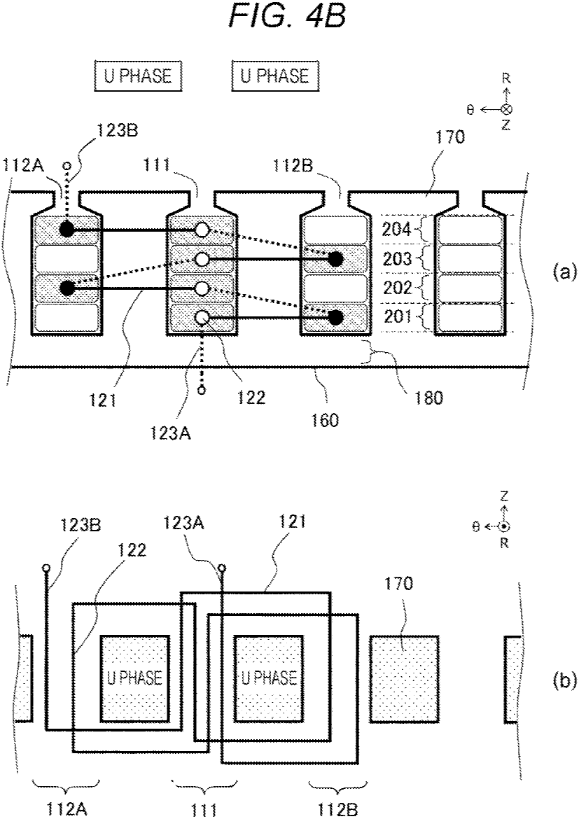

Next, a winding form of the phase coil 120G will be described in detail. FIG. 4A is a partial connection diagram of the stator of the rotary electric machine according to the first embodiment as viewed from the axial direction Z (see FIG. 1) and the radial direction R (see FIG. 1). Since the stator 101 of the actual rotary electric machine 100 has a substantially columnar shape or a substantially cylindrical shape, it has a structure having a finite curvature in the circumferential direction θ. However, in the drawings after FIG. 4A, a schematic diagram in which the circumferential direction is illustrated linearly is used to simply illustrate the structure of the present invention. FIG. 4A illustrates a U phase connection form in a case where two teeth 170 generating an in-phase magnetic field are arranged in the circumferential direction in a concentrated winding/fractional slot structure.

In FIG. 4A, each slot 110 is configured such that four coils form four layers in the radial direction. In an in-phase slot 111, four coils are arranged in a line. In the following description, four regions in the radial direction corresponding to the positions of the four coils placed in the slot are also defined as layers. Similarly to FIG. 3, also in this drawing, the first layer 201, the second layer 202, the third layer 203, and the fourth layer 204 are defined in order from a position close to the back yoke 180 toward the gap 109. The number of layers included in one slot is determined by the number of turns of the coil. In this drawing, the structure of four layers is illustrated as an example, but the number of layers per slot may be any number of stages of two or more stages.

Attention is paid to a phase coil having a U phase (hereinafter, the coil is also referred to as a U-phase coil) in FIG. 4A. The lead-out wire 123A of the U-phase coil extends in a positive direction from a negative direction in the axial direction Z (see FIG. 1) to become a conductor slot portion 122a in an out-of-phase slot 112A, and extends the first layer 201 in the positive direction in the axial direction Z. The conductor slot portion 122a reaching a positive terminal end in the axial direction Z of the stator core 160 passes through the conductor crossover portion 121a directed to the adjacent in-phase slot 111 and becomes a conductor slot portion 122b in the in-phase slot 111. The conductor slot portion 122b in the in-phase slot 111 extends in the first layer 201 in the in-phase slot 111 in the negative direction of the axial direction Z.

The conductor slot portion 122b in the in-phase slot 111 that reaches the negative terminal end in the axial direction Z of the stator core 160 further passes through the conductor crossover portion 121b directed to the adjacent out-of-phase slot 112B, and becomes the conductor slot portion 122c in the out-of-phase slot 112B. Here, since the conductor slot portion 122c in the slot is located in the second layer 202, movement in the radial direction for one layer occurs between the in-phase slot 111 and the out-of-phase slot 112B. The U-phase coil is folded in the circumferential direction in the out-of-phase slot 112B, passes through the conductor crossover portion 121c directed to the in-phase slot 111, and becomes a conductor slot portion 122d in the in-phase slot 111. The conductor slot portion 122d in the in-phase slot 111 extends in the negative direction of the axial direction Z in the second layer 202 of the in-phase slot 111. The conductor slot portion 122d in the slot reaching the negative terminal end in the axial direction Z of the stator core 160 further passes through the conductor crossover portion 121d directed to the adjacent out-of-phase slot 112A, and becomes a conductor slot portion 122e in the out-of-phase slot 112A. Here, the conductor slot portion 122e in the slot has moved to the third layer 203. Hereinafter, the passage between the slots and the movement of the layer are repeated according to the winding and the turn of the series of phase coils. Finally, the coil is drawn to the outside of the stator 101 from the lead-out wire 123B. Referring to FIG. 4A (b), it can be read that the current directions of the U-phase coils are aligned in each slot.

Although only the U-phase coil is focused here, the other V-phase and W-phase coils are also wound around the stator 101 similarly to the U-phase coil. In this case, coils of other phases are inserted into the out-of-phase slot 112A and the out-of-phase slot 112B in addition to the U-phase coil. That is, there is a slot in which two phase coils having different phases are inserted into one slot. Here, a slot into which only coils of the same phase are inserted is represented as the in-phase slot 111, and a slot into which two phase coils having different phases are inserted is represented as the out-of-phase slot 112.

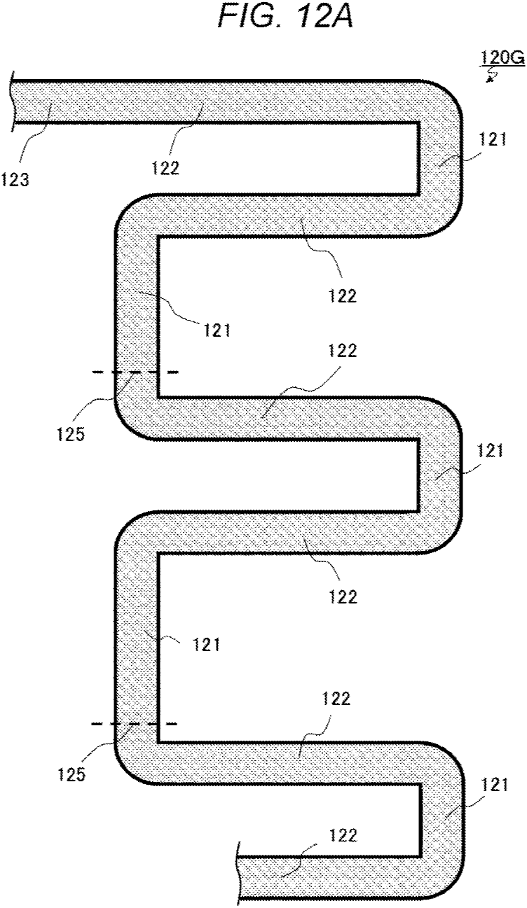

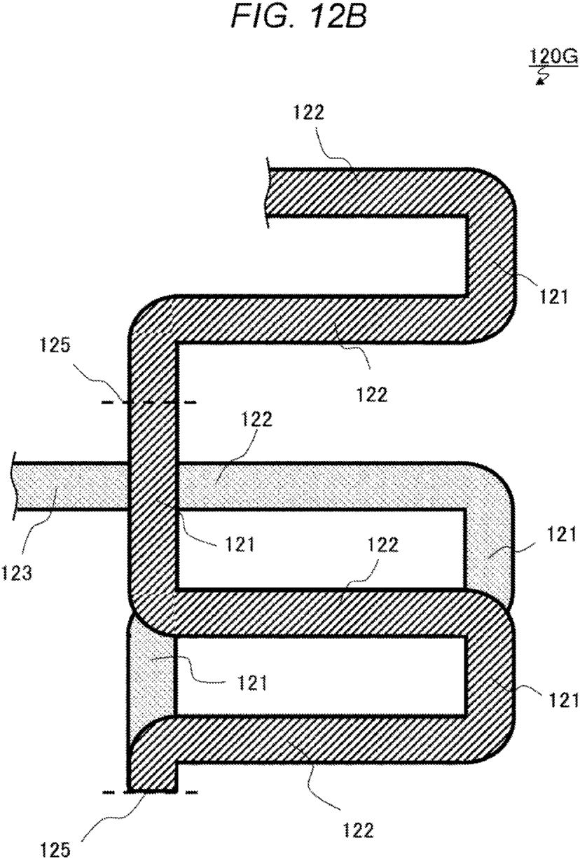

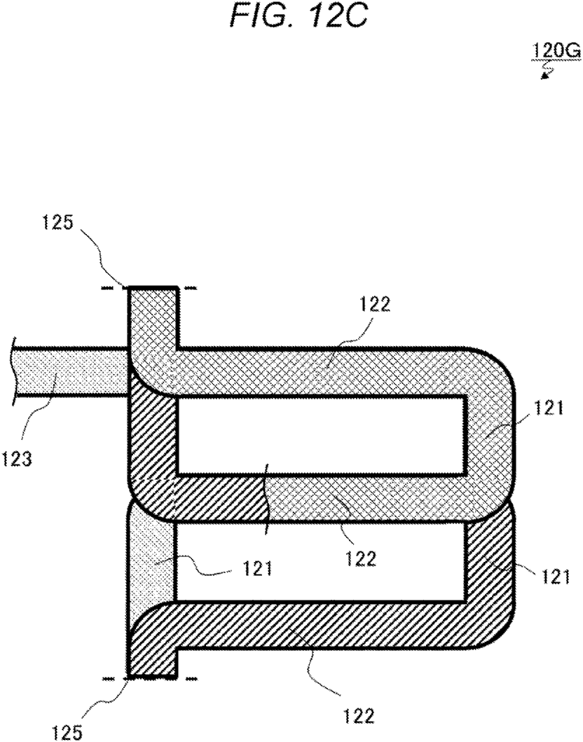

In the present invention, the coil is wound so as to extend over adjacent slots in a zigzag manner in the axial direction Z (see FIGS. 12) and to reciprocate in the circumferential direction θ between the out-of-phase slots 112 via the in-phase slots 111. Here, the coil may be a continuous coil as illustrated in FIGS. 12, or may be a coil in which coil elements separated in the middle are connected. For example, the conductor slot portion and the conductor crossover portion may be to be configured as an integrated coil element, and the plurality of coil elements may be connected by any one of welding, soldering, fitting, plating, and crimping. In addition, one phase coil straddles the in-phase slot 111 and the out-of-phase slot 112 in a state of being shifted in the radial direction R by one layer. In the stator having the concentrated winding/fractional slot structure, since two or more teeth 170 that generate the in-phase magnetic field are arranged in the circumferential direction, the phase coil is wound at least over a group of three or more slots 110 arranged continuously.

FIG. 4A illustrates a case where the layer is shifted by one stage out of the total number of stages of four when extending from the in-phase slot 111 to the out-of-phase slot 112. However, the embodiment of the present invention is not limited thereto. FIG. 4B is a partial connection diagram of a stator of a rotary electric machine according to a modification of the first embodiment of the present invention as viewed from the axial direction Z and the radial direction R. For example, FIG. 4B illustrates an example in which the layer is shifted by one stage from the out-of-phase slots 112A and 112B to the in-phase slot 111. As illustrated in FIGS. 4A and 4B, a structure in which the layer of the coil in the slot moves one stage when the coil extends from the in-phase slot 111 to the out-of-phase slot 112 or from the out-of-phase slot 112 to the in-phase slot 111 is preferable. However, basic effects of the present invention can also be obtained in a structure in which the layer of the coil moves in two or more stages from the in-phase slot 111 to the out-of-phase slot 112 or from the out-of-phase slot 112 to the in-phase slot 111. Also in FIG. 4B, it can be read that the current directions of the U-phase coils are aligned in each slot.

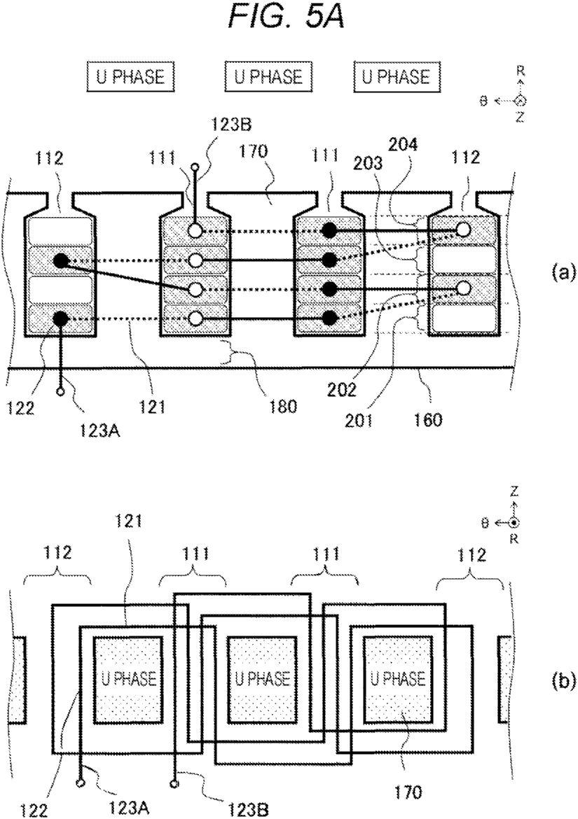

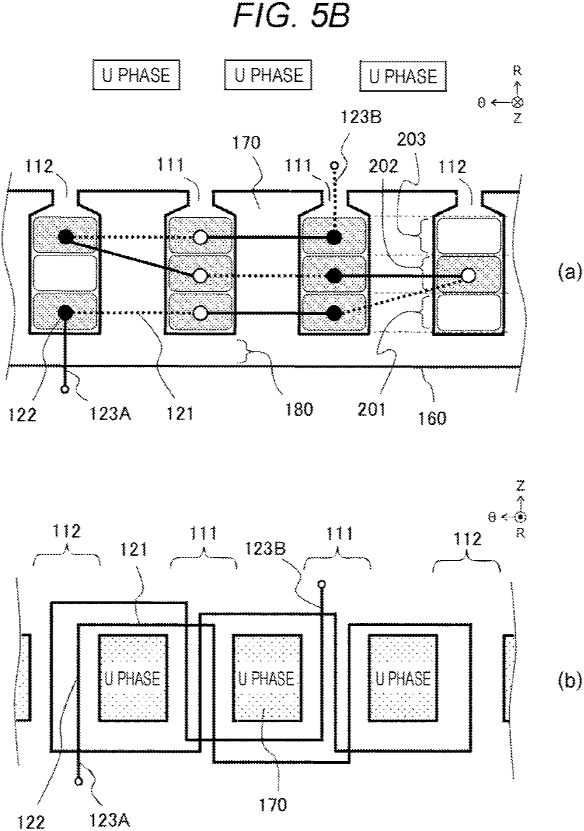

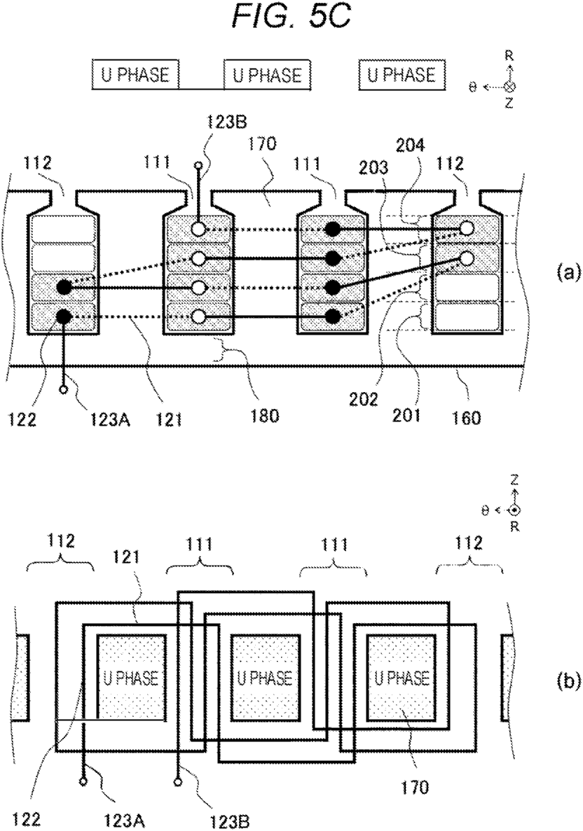

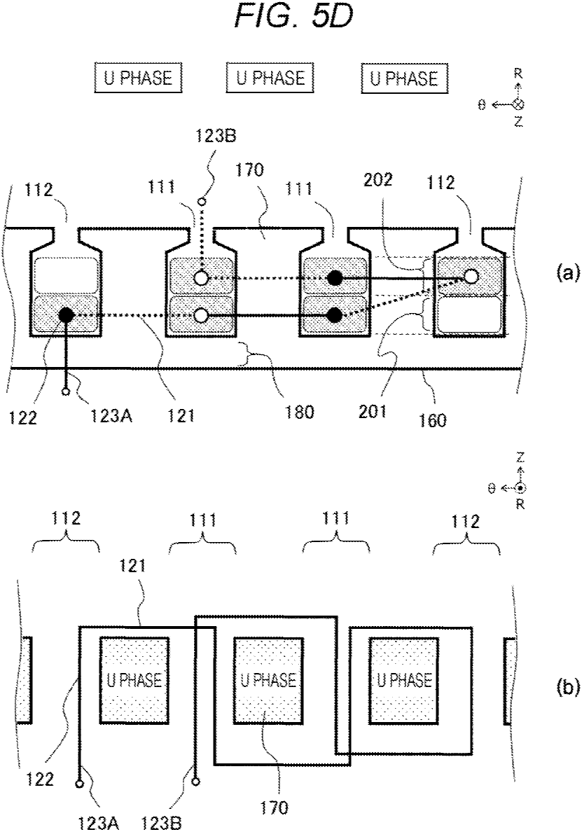

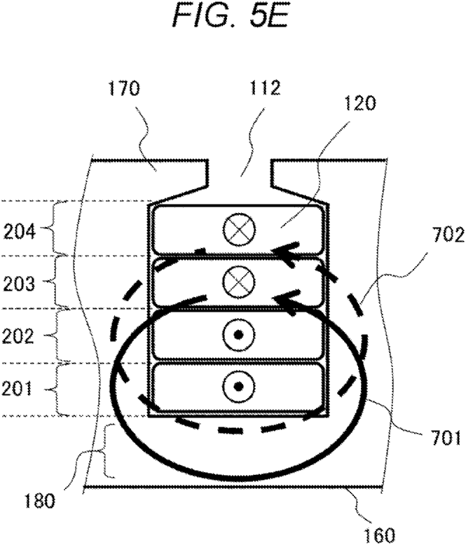

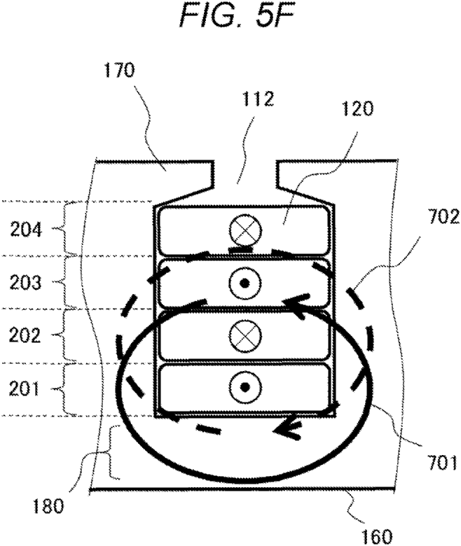

FIGS. 5A to 5D are partial connection diagrams of a stator of a rotary electric machine according to another modification of the first embodiment of the present invention as viewed from the axial direction Z and the radial direction R. FIGS. 5A to 5D illustrate a U-phase connection form in a case where three teeth 170 generating an in-phase magnetic field are arranged in the circumferential direction, that is, two in-phase slots 111 are continuously arranged in the circumferential direction in the concentrated winding/fractional slot structure.

Also in this case, similarly to FIG. 4A, the phase coil 120G is wound so as to cross the adjacent slots while zigzagging in the axial direction Z and reciprocate in the circumferential direction θ between the out-of-phase slots 112 via the in-phase slot 111.

However, in a case where the coil extends between the in-phase slots 111, the coil extends to the adjacent in-phase slots 111 in a state where the same layer is maintained without shifting the arranged layers. The same applies to a case where three or more in-phase slots 111 are continuously arranged in the circumferential direction. Even when two or more in-phase slots 111 are continuously arranged in the circumferential direction, the effects of the present invention can be obtained by the similar configuration. Next, the operation of the present embodiment will be described.

According to the present invention, in the concentrated winding/fractional slot structure, it is possible to form a state in which the phase coils are not in contact with each other in the circumferential direction θ of the rotary electric machine by adopting a winding structure in which the coil of the square wire is continuously crossed from one out-of-phase slot 112 to the other out-of-phase slot 112. In addition, with reference to FIGS. 5A, 5B, 5C, and 5D, it can be read that the current directions of the U-phase coils are aligned in each slot, similarly to FIGS. 4A and 4B.

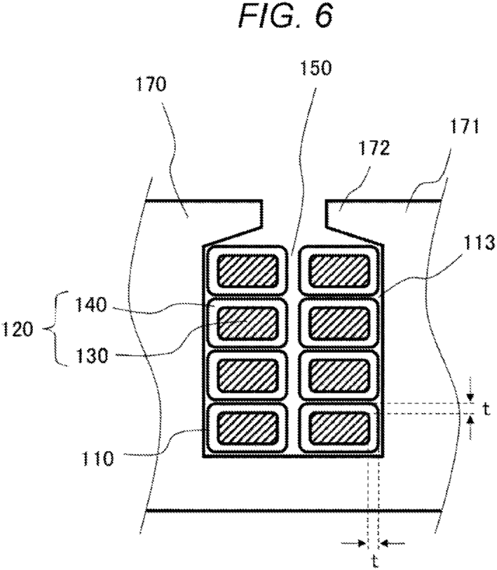

Here, FIG. 6 is a cross-sectional view of a slot provided in a stator core of a rotary electric machine of the related art. In the structure of concentrated winding in the related art, since the phase coil 120G is wound around one tooth 170, two rows of coils 120 are arranged in the circumferential direction θ inside the slot 110. In order to prevent the element wires 130 in the slot 110 from being electrically shortcircuited, insulation is required around the element wires 130. In particular, in the case of the out-of-phase slot 112, since two coils 120 having different phases are inserted, the insulation of the coils is designed based on the withstand voltage required for the out-of-phase slot 112. For this reason, in the related art, since the coils 120 of different phases are arranged in the circumferential direction θ, the insulating film 140 having a sufficient thickness to insulate these coils 120 from each other is required.

Here, the thickness of the insulating film 140 is defined as t. That is, it is sufficient that the insulation between the two coils 120 having different phases has an insulating film having a thickness of 2t, but in this case, the sum of the insulating films in the circumferential direction θ is 4t per slot 110. Therefore, the conventional concentrated winding structure is advantageous in that the stator 101 can be manufactured by a common coil winding method regardless of whether it is a fractional slot structure or not, but a volume occupied by the insulating film 140 for each slot 110 increases, and a space factor is small.

Meanwhile, as illustrated in FIG. 3 described above, the coil winding structure of the present invention has a winding structure in which the coils 120 are arranged one by one in the radial direction of the slot with respect to the slot 110 in the concentrated winding/fractional slot structure and interwoven. In this coil winding structure, the coils 120 are arranged in the radial direction R in the slots 110 and are not in contact with each other in the circumferential direction θ.

Similarly to the related art, in the present invention, the insulation of the coil is designed based on the required withstand voltage between the coils 120 of different phases in the out-of-phase slot 112. In the present invention, since the coils 120 of different phases are arranged in the radial direction R, the insulating film 140 having a thickness sufficient to insulate the coils 120 from each other is required. Similarly to the conventional technique, the thickness of the insulating film 140 is defined as t. In this case, the sum of the insulating films 140 between the plurality of coils 120 in the radial direction R is 2t, and there is no problem in the insulation property. The sum of the insulating films in the radial direction R is the same as that in the related art.

On the other hand, the sum of the insulating films in the circumferential direction θ is 2t per one slot 110, which is half of that in the related art. Therefore, although the volume of the insulating film 140 is reduced as compared with the related art, the withstand voltage is equivalent to that of the related art. Therefore, the winding structure limited to the concentrated winding and fractional slots in the present invention can reduce the volume occupied by the insulating film 140 with respect to each slot 110, and in particular, can reduce the amount of the insulating film in the circumferential direction θ by half. Therefore, the space factor of the coil can be improved.

In the concentrated winding of the related art, a dead space 150 (see FIG. 6) is required between the coils in the circumferential direction θ due to manufacturing tolerance or the like. In some cases, an insulating material such as an insulation paper is provided, and the coil space factor is further reduced. Meanwhile, in the winding structure of the present invention, since there is no contact or interference between the coils 120 in the circumferential direction θ, there is no unnecessary gap between the coils in the circumferential direction. Alternatively, insulation paper for obtaining insulation property in the circumferential direction becomes unnecessary. Therefore, the space factor of the coil is further improved. The improvement of the space factor can reduce the copper loss of the coil 120, that is, the amount of heat generated in the coil 120. Therefore, the torque density of the rotary electric machine 100 can be improved by using the margin for the downsizing of the rotary electric machine 100, specifically, the reduction of the cross section of the slot 110 (See FIGS. 1 and 2).

As illustrated in FIGS. 4A, 4B, and 5A, in a case where the number of layers is an even number (four layers in each of the drawings on the left), the lead-out portion 123 can be aggregated at the same end (end in the coil end direction) in the axial direction Z. As a result, since wire connection work of the lead-out wire is completed only on one end side in the axial direction, assembly workability of the coil is improved. In addition, since a wire connection space can be reduced, the rotary electric machine can be downsized.

Meanwhile, as illustrated in FIG. 5B, when the number of layers is an odd number (three layers in FIG. 5B), the lead-out portion 123 can be distributed to both end sides in the axial direction Z. As a result, a degree of freedom of a connection layout is improved.

The above effect can also be obtained in a structure in which the layer of the coil moves in two or more stages when the coil extends from the in-phase slot 111 to the out-of-phase slot 112 or from the out-of-phase slot 112 to the in-phase slot 111, for example, as illustrated in FIG. 5C. However, when a structure is adopted in which the layer of the coil moves one step when the coil extends from the in-phase slot 111 to the out-of-phase slot 112 or from the out-of-phase slot 112 to the in-phase slot 111, the sum of the lengths of the conductor crossover portions 121 extending over the in-phase slot 111 and the out-of-phase slot 112 is minimized, and the winding resistance of the coil can be minimized.

Since the copper loss of the coil is proportional to the magnitude of the winding resistance of the coil, it is possible to further reduce the amount of heat generation in the coil under a condition where the winding resistance of the coil is minimum, and it is possible to further improve the torque density of the rotary electric machine 100.

In addition, since the heat generation in the coil can also be said to be a loss, an aspect in which the layer of the coil moves by one stage when the coil extends from the in-phase slot 111 to the out-of-phase slot 112 or from the out-of-phase slot 112 to the in-phase slot 111 is also effective from the viewpoint of reducing the loss generated in the coil. Finally, FIG. 5D is a modification of the first embodiment, and illustrates a case where the total number of layers is two and two in-phase slots are continuously arranged.

Next, FIG. 5E is a conceptual diagram of the current flowing through the coil of the out-of-phase slot according to the modification of the first embodiment of the present invention and the magnetic flux generated by the current. FIG. 5E is a cross-sectional view of the out-of-phase slot 112 in a case where the layer of the coil 120 moves two or more stages when the coil 120 extends from the in-phase slot 111 to the out-of-phase slot 112, or from the out-of-phase slot 112 to the in-phase slot 111.

Meanwhile, FIG. 5F is a cross-sectional view of the out-of-phase slot 112 in a case where the layer of the coil 120 moves by one stage when the coil 120 moves from the in-phase slot 111 to the out-of-phase slot 112 or from the out-of-phase slot 112 to the in-phase slot 111.

Since coils of two different phases are inserted into the out-of-phase slot 112, the directions of currents may be reversed between coils of different phases at a certain moment.

In FIGS. 5E and 5E, the direction of the current flowing to each coil 120 at a certain moment is illustrated, which means that the coils having the same current direction are in phase and the coils having different current directions are in different phases. In the case of the configuration of FIG. 5E, at least one set of the in-phase coils 120 is continuously arranged in the radial direction R, but in the case of the configuration of FIG. 5F, the in-phase coils are not continuously arranged in the radial direction R. For example, in FIG. 5E, in-phase coils are continuously arranged in the first layer 201 and the second layer 202.

In this case, the magnetic flux generated around the slot by the coil is considered. In each cross-sectional view, a magnetic flux 701 generated by the current flowing through the coil 120 disposed in the first layer 201 and a magnetic flux 702 generated by the current flowing through the coil 120 disposed in the second layer 202 are illustrated. In the configuration of FIG. 5E, since the magnetic fluxes 701 and 702 formed by the in-phase coils are superimposed, an increase in an AC resistance value of the coil 120 due to a proximity effect by the magnetic fluxes becomes remarkable. The increase in the AC resistance value leads to an increase in a harmonic loss generated in the coil 120.

Meanwhile, when the orientations of the magnetic fluxes 701 and 702 formed by the coils of different phases are opposite to each other as in the configuration of FIG. 5F, the magnetic fluxes partially cancel each other due to the superposition of the magnetic fluxes, and an increase in the AC resistance value of the coil 120 can be reduced.

For example, the AC resistance loss generated in each of the out-of-phase slots 112 is calculated by magnetic field analysis using a PWM voltage waveform. As a result, assuming that the loss amount in the configuration of FIG. 5E is 1.00 pu, the loss amount is 0.90 pu in the configuration of FIG. 5F, and it has been found that the loss can be reduced by 10%. As described above, the structure in which the layer of the coil 120 moves by one stage when the coil 120 extends from the in-phase slot 111 to the out-of-phase slot 112 or from the out-of-phase slot 112 to the in-phase slot 111 exhibits an excellent effect. That is, it is a suitable structure capable of reducing the loss due to the AC resistance generated in the coil.

### Second Embodiment

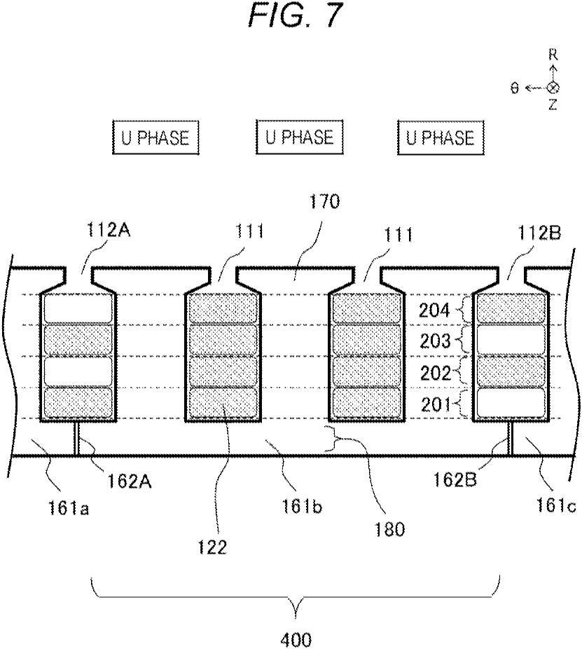

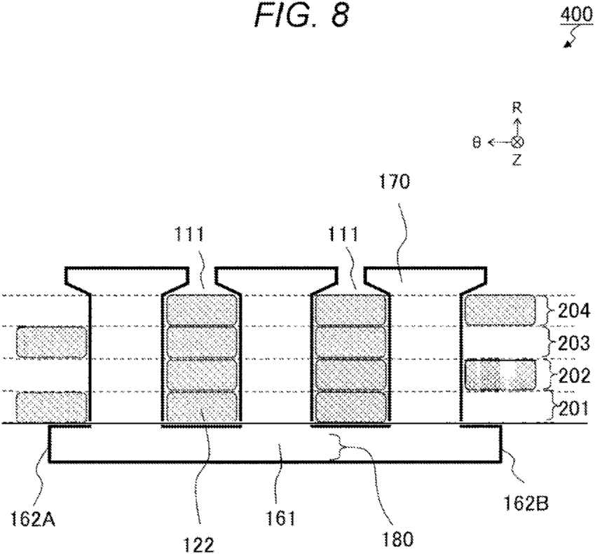

A second embodiment will be described with reference to FIGS. 7 and 8. FIG. 7 is a partial cross-sectional view of a stator of a rotary electric machine according to a second embodiment of the present invention. Description of matters overlapping with the first embodiment will be omitted.

An iron core of the stator in the second embodiment is formed by combining split cores 161a, 161b, and 161c. The core split portions 162A and 162B of the split core are in the back yoke 180 of the stator and overlap the out-of-phase slot 112 in the circumferential direction θ. For example, in FIG. 7, in the concentrated winding/fractional slot structure, the U-phase coil 120 in a case where three teeth 170 that generate the in-phase magnetic field are arranged in the circumferential direction is indicated by hatching with shading. The split core is configured to divide the stator core in the circumferential direction, and the number of divisions is about 10 to 15, for example. In addition, it is assumed that about several to 10 slots are provided in one split core.

In this case, the U-phase coil is wound around the split core 161b, the core split portion 162A is in a portion of the back yoke 180 overlapping the out-of-phase slot 112A in the circumferential direction θ, and the core split portion 162B is in a portion of the back yoke 180 overlapping the out-of-phase slot 112B in the circumferential direction (θ). Similarly, a V-phase coil or a W-phase coil different from the U-phase coil 120 is wound around each of the split cores 161a and 161c.

As in the structure of the present embodiment, a split stator in which each phase coil is wound can be formed by winding a coil of one phase for each split core. FIG. 8 is a cross-sectional view of a split stator 400 according to the present embodiment. Since the coil of the split stator 400 is wound with only one phase coil, winding of one phase coil is completed in the split stator 400. Therefore, a plurality of split stators 400 can be assembled first, and then the plurality of split stators 400 can be combined to form the stator 101. As compared with the stator 101, the split stator 400 is small and thus has good assembly workability. In addition, in the split stator 400, the out-of-phase slot 112 into which two phase coils having different phases are inserted is divided. Therefore, since the interference of the coils of different phases does not occur at the time of winding the phase coils, the winding performance of the coils is good. From the above reasons, according to the present embodiment, coil winding performance and assembly workability of a stator having a concentrated winding/fractional slot structure are improved, and mass productivity of a rotary electric machine is improved.

### Third Embodiment

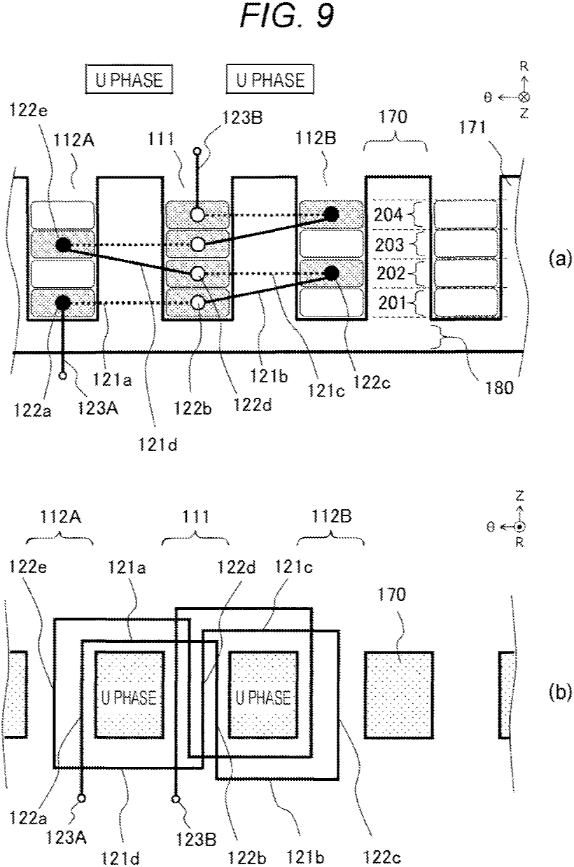

Next, a third embodiment will be described with reference to FIGS. 9 to 15. FIG. 9 is a partial connection diagram of a stator of a rotary electric machine according to the third embodiment of the present invention. FIG. 9 illustrates a U-phase connection form in a case where two teeth 170 generating in-phase magnetic fields are arranged in the circumferential direction in the concentrated winding/fractional slot structure. Note that description of matters overlapping with the first and second embodiments will be omitted. Similarly to the above-described embodiments, referring to FIG. 9, it can be read that the current directions of the U-phase coils are aligned in each slot.

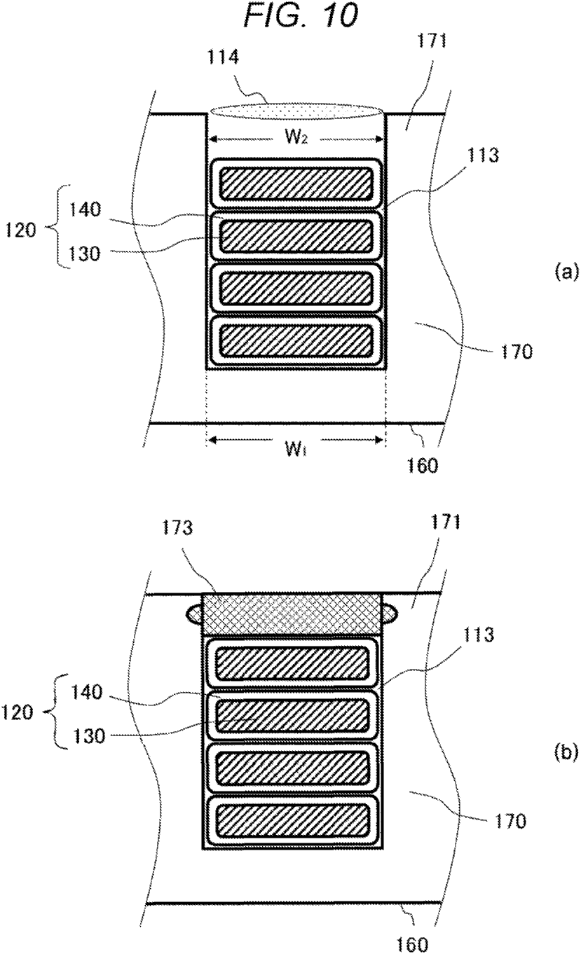

The tee stop 171 of the stator of the rotary electric machine in the third embodiment is configured by a so-called open type slot without having the overhanging portion 172. FIG. 10 is a partial cross-sectional view of the slot of the stator of the rotary electric machine according to the third embodiment, and FIG. 10 is a partial cross-sectional view of a slot of a stator of a rotary electric machine according to a modification of the third embodiment. In the present embodiment, a width (minimum width) W₁ of the slot and a width (minimum width) W₂ of the slot opening portion 114 have a relationship of W₁ ≤ W₂. That is, the slot is an open type slot in which the opening portion of the slot is wider than the bottom surface side of the slot.

As illustrated in FIG. 10, the slot opening portion 114 may be closed by a wedge 173. The material of the wedge 173 may be a magnetic material or a non-magnetic material. In the case of an open-type slot in which the width W₂ of the slot opening portion 114 is larger than the width W₁ of the slot as in the structure of the present modification, the coil 120 wound in advance can be incorporated into the stator core 160 later. Accordingly, assembly workability of the stator 101 is remarkably improved.

When the iron core of the stator is not divided as in the first embodiment, the phase coils 120G of the respective phases interfere with each other in the out-of-phase slots 112. Therefore, it is necessary to simultaneously incorporate the coils of the respective phases into the iron core. However, in a case where the stator core 160 of the stator is configured by the split core as in the second embodiment (see FIG. 7), the coil wound in advance is incorporated into the split core. Therefore, the stator can be manufactured only by combining the split stators 400 in which the coils are incorporated. As a result, assembly workability of the stator having the concentrated winding/fractional slot structure is improved, and mass productivity of the rotary electric machine is improved.

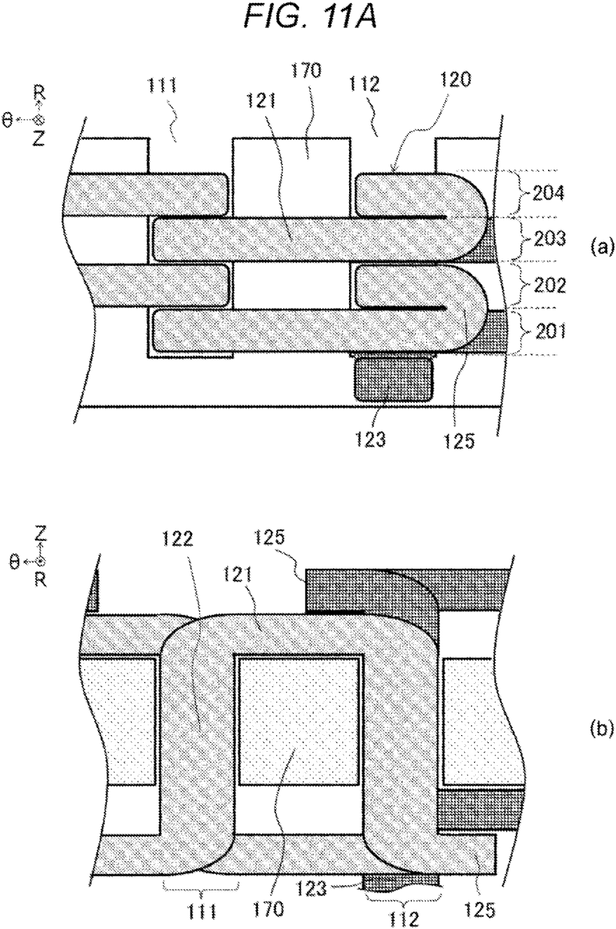

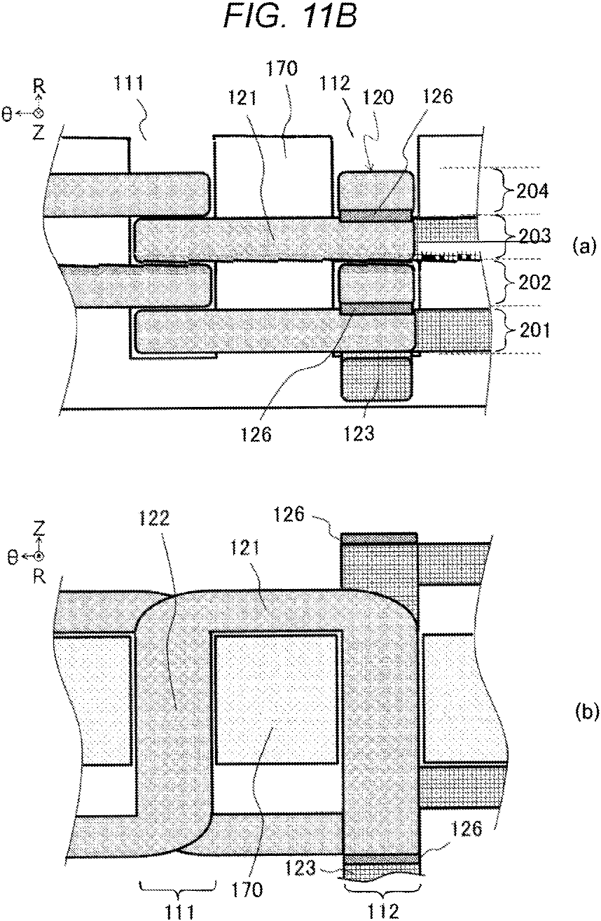

FIG. 11A is a partially enlarged view of the coil of the rotary electric machine according to the third embodiment. This drawing illustrates a winding structure in which a folded portion 125 is provided at the conductor crossover portion 121 of the coil extending from the in-phase slot 111 to the out-of-phase slot 112 (or vice versa). According to this configuration, the coil can be manufactured by punching out one conductive thin plate, or can be manufactured by bending one rectangular wire. At least three or more coils are wound so as to be folded by 180° in the circumferential direction θ from the position of the coil end of the last tooth 170 on the way across a group of slots arranged continuously. The conductor crossover portion 121 extending from the in-phase slot 111 to the out-of-phase slot 112 (or vice versa) can be formed by folding the coil 180° at the folded portion 125. In this case, by shifting the folded portion 125 to the outside of the slot by a width equal to or larger than the width of the conductor crossover portion 121 of the coil of another layer in the axial direction Z, the coil can be formed without interfering with the coil of a different phase wound together in the out-of-phase slot 112.

In this case, the folded portion is disposed so as to protrude in the axial direction by a length equal to or longer than a protruding length in the axial direction of the coil end of the coil of another layer. Then, a gap exists between the coil end and the side portion of the tooth 170. That is, the axial size of the stator increases by the amount of the gap. However, an effective area where the coil end is in contact with the surrounding air substantially increases, which is preferable from the viewpoint of actively cooling the coil end.

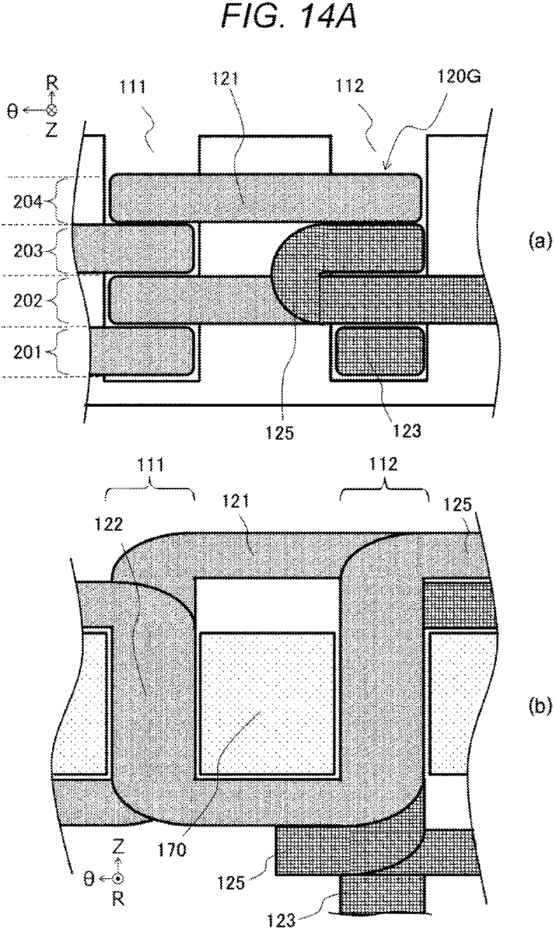

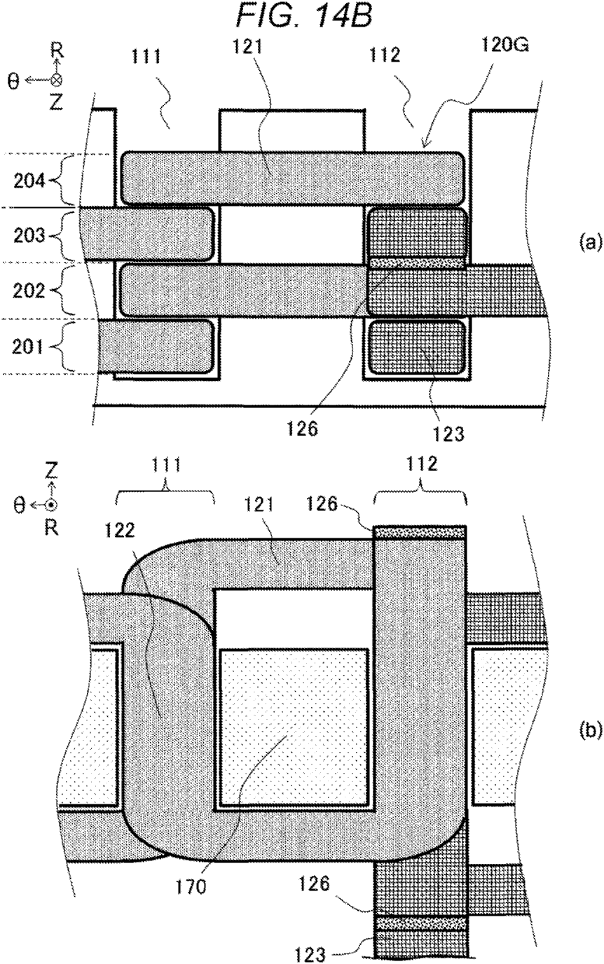

When it is difficult to fold the coil at the folded portion 125, the folded portion 125 may be replaced with a connecting portion 126 as illustrated in FIG. 14B. In this case, the coil in the section from the one connecting portion 126 (or the lead-out portion 123) to the other connecting portion 126 is manufactured by punching out and forming a thin plate or bending and forming one rectangular wire. Then, the thin plates may be stacked on the basis of the connection diagram of FIG. 9, and the portions of the connecting portion 126 may be connected in a subsequent process by any one of welding, soldering, fitting, plating, and crimping to form the coil. Alternatively, a plurality of welding, soldering, fitting, plating, and crimping may be used in combination.

As described above, one phase coil placed between the positive lead-out wire and the negative lead-out wire of the lead-out portion is wound so as to be folded and reciprocated between the two out-of-phase slots. Therefore, it is easy to apply a coil formed from a thin plate or a coil formed by bending one rectangular wire.

FIGS. 11A and 11B illustrate a case where two teeth 170 that generate in-phase magnetic fields are arranged in the circumferential direction in the concentrated winding/fractional slot structure. FIG. 12A illustrates a plan view of the phase coil 120G before being folded, which is punched out and formed from a metal thin plate corresponding to the coil layout of FIG. 11A or obtained by bending one rectangular wire. The phase coil 120G can be integrally formed by punching out the phase coil 120G from a thin plate as in FIG. 12A or bending one rectangular wire. The phase coil 120G may be formed not only by punching out thin plate but also by shaving, cutting, casting, or machining that is easy to manufacture, such as an additive manufacturing method (AM method). FIG. 12B illustrates a plan view of a state in which the phase coil 120G of FIG. 12A is folded once at the folded portion 125. In FIG. 12C, the form of the coil in a state of being further bent once and wound around the teeth is completed. The phase coil 120G illustrated in FIG. 12C can be disposed so as to be fitted into an open type slot. With the phase coil 120G of this form, it is not necessary to actually wind the electric wire between the teeth (slots), and the required time can be shortened, which is advantageous in terms of manufacturing. Since the lead-out portion 123 in FIGS. 11A and 11B is located at the position of the first layer 201 in the slot, when the lead-out portion is directly extended to the outside, the lead-out portion interferes with the folded portion 125 of the coil of the different phase. Therefore, bending of about 90° is performed twice so as to be a layer one layer lower than the first layer, and the terminal is led out as a terminal to the outside in the axial direction.

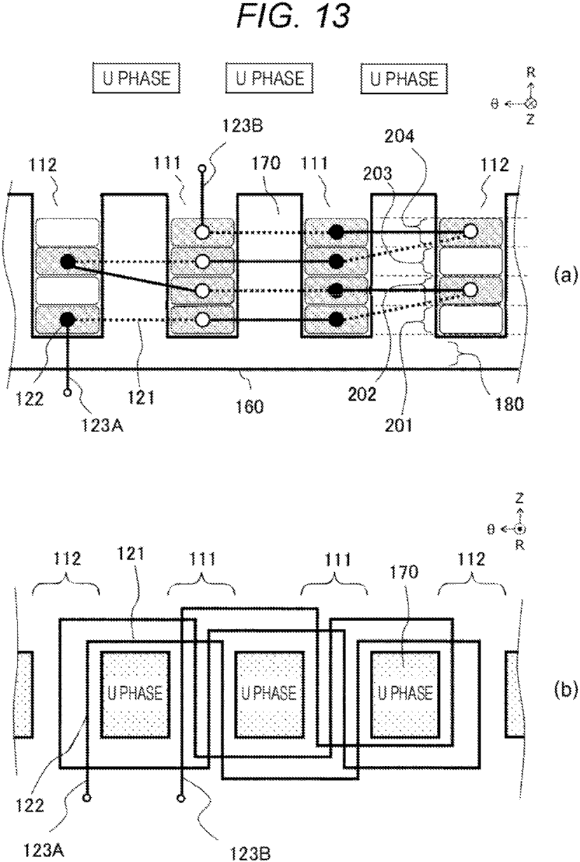

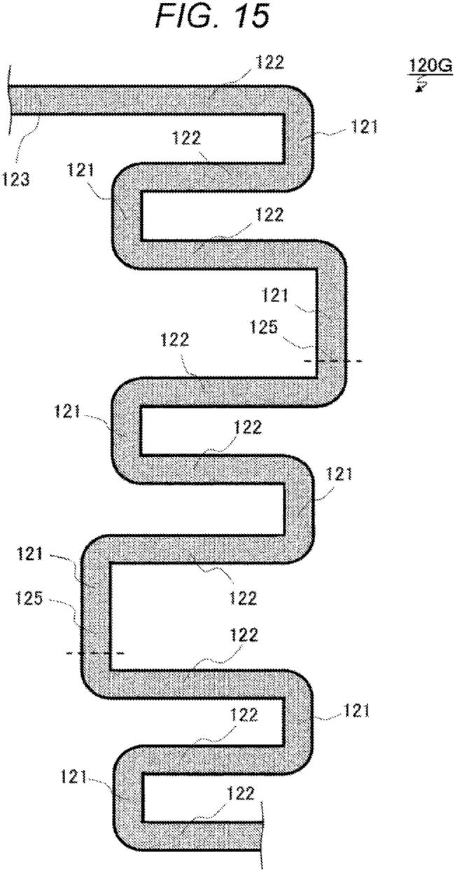

Next, FIGS. 13 to 15 illustrates a case where three teeth 170 that generate in-phase magnetic fields are arranged in the circumferential direction as a modification of the third embodiment. FIG. 13 is a partial connection diagram of a stator of a rotary electric machine according to the modification of the third embodiment. FIG. 14A is a partially enlarged view of the coil of the rotary electric machine according to the modification of the third embodiment. FIG. 15 illustrates a plan view of a coil before folding, which is punched out and formed from a thin plate according to a modification of the third embodiment of the present invention or obtained by bending one rectangular wire. Similarly, when three or more teeth 170 that generate the in-phase magnetic fields are arranged in the circumferential direction, the phase coil 120G can be formed from one metal plate or one rectangular wire can be bent regardless of the number of layers. When it is difficult to fold the coil at the folded portion 125, the folded portion 125 may be replaced with the connecting portion 126 as illustrated in FIG. 14B. In this case, the coil in the section from the one connecting portion 126 (or the lead-out portion 123) to the other connecting portion 126 is manufactured by punching out and forming a thin plate or bending and forming one rectangular wire. Then, the thin plates may be stacked on the basis of the connection diagram of FIG. 9, and the portions of the connecting portion 126 may be connected in a subsequent process by any one of welding, soldering, fitting, plating, and crimping to form the coil.

In particular, by forming the phase coil 120G from one metal plate, the number of times of bending of the coil can be reduced as compared with the case where the winding coil is produced by the winding nozzle or the manual winding. Therefore, manufacturability and winding easiness of the phase coil 120G are improved. Further, unlike the conventional conductor crossover portion 121, there is no bending in the axial direction Z, and only bending in the circumferential direction θ is performed. Therefore, it is possible to adopt a flat coil having a wide width in the circumferential direction θ and a narrow width in the radial direction R in the slot 110. By using the flat coil, it is possible to reduce the AC resistance loss generated from the skin effect and the proximity effect in the coil. As a result, the amount of heat generated in the coil can be further reduced, and the torque density of the rotary electric machine can be further improved.

Further, the width of the coil does not need to be equal between the conductor slot portion 122 and the conductor crossover portion 121. By making the width of the conductor crossover portion 121 narrower than the width of the conductor slot portion 122, the coil weight can be reduced, and the torque density of the rotary electric machine can be improved. Furthermore, the width of the conductor crossover portion 121 can be made wider than the width of the conductor slot portion 122 to reduce heat generation of the coil and simplify a cooling system (not illustrated) of the coil. Thus, it is possible to achieve miniaturization and weight reduction of the entire rotary electric machine system.

### Fourth Embodiment

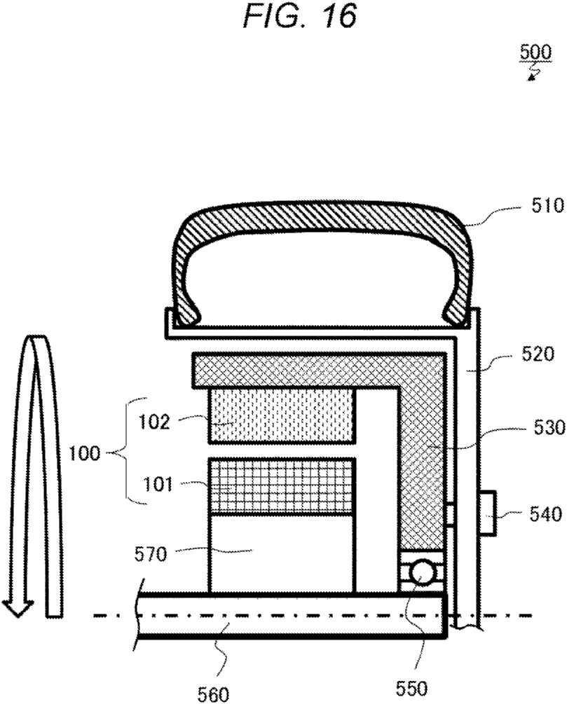

A fourth embodiment will be described with reference to FIG. 16. FIG. 16 is a conceptual diagram of a cross section of an electric wheel 500 according to the fourth embodiment. An outer rotor type rotary electric machine 100 is used for the electric wheel 500. The rotor 102 of the rotary electric machine 100 is connected to a rotor frame 530. The rotor frame 530 is connected to the wheel 520 by a connecting member 540. A tire 510 is fitted to the wheel 520. In order that the wheel 520 and the rotor 102 are rotatably supported with respect to a shaft 560, the wheel 520 or the rotor frame 530 is connected to the shaft 560 by a bearing 550. Meanwhile, the stator 101 of the rotary electric machine 100 is fixedly supported by the shaft 560 by a support member (not illustrated), and an electric circuit 570 is also mounted on the support member. The electric circuit 570 supplies electric power to the stator 101 to rotate the rotor 102. The rotation of the rotor 102 is transmitted to the wheel 520 via the rotor frame 530 and the connecting member 540 to rotate the wheel 520.

When the structure of the present embodiment is adopted, since the torque density of the rotary electric machine 100 is high, the rotary electric machine 100 can not only be accommodated on an inner peripheral side of the wheel 520, but also can be gearless, that is, direct drive of the wheel 520. Conventional electric wheels use gears, and there have been problems such as wear and noise of the gears and an increase in the number of bearings used because the gears need to be supported.

On the other hand, since the electric wheel 500 using the rotary electric machine 100 of the present invention having a high torque density does not require a gear, maintenance in consideration of wear of the gear becomes unnecessary, and noise generated from the gear disappears. In addition, an amount of use of the bearing is minimized, risk of wear of the bearing is reduced, and an amount of maintenance work such as grease replacement of the bearing can be reduced. In addition, since the volume of the rotary electric machine 100 is small, the electric circuit 570 can also be mounted inside the wheel 520, and it is possible to reduce the size and weight of the electric wheel 500 by a synergistic effect with the gearless configuration.

### Fifth Embodiment

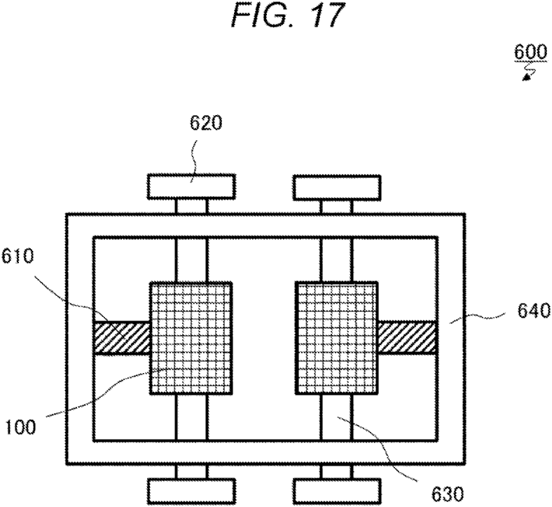

A fifth embodiment will be described with reference to FIG. 17. FIG. 17 is a conceptual diagram of a railway vehicle 600 according to the fifth embodiment. An inner rotor type rotary electric machine 100 is used for the railway vehicle 600. The rotary electric machine 100 is fixed and supported by a carriage 640 by a support member 610. The rotor 102 of the rotary electric machine 100 is directly connected to an axle 630, and the rotary electric machine 100 drives vehicle wheels 620 via the axle 630.

Since the torque density of the rotary electric machine 100 is high, the rotary electric machine of the present embodiment can be adopted for the railway vehicle, and gearless, that is, direct drive of the vehicle wheels 620 can be performed. Conventional railway vehicles use gears, and there have been problems such as wear and noise of the gears and an increase in the number of bearings used because the gears need to be supported. On the other hand, since the railway vehicle 600 using the rotary electric machine 100 having a high torque density of the present invention does not require a gear, maintenance in consideration of wear of the gear becomes unnecessary, and noise generated from the gear disappears. In addition, the amount of use of the bearing is minimized, the risk of wear of the bearing is reduced, and the amount of maintenance work for grease replacement or the like of the bearing can be reduced. In addition, since the volume of the rotary electric machine 100 is small, it is possible to reduce the size and weight of the railway vehicle 600 by a synergistic effect with the gearless configuration.

The rotary electric machine of the present invention is not limited to a railway vehicle, and can be used without any problem as long as it is a vehicle including a rotary electric machine in a carriage, such as a bus, a work vehicle, or a monorail, and applying a driving force from a rotating shaft to a tire, a vehicle wheel, or the like.

Reference Signs List

| | |
|---|---|
| 100 | rotary electric machine |
| 101 | stator |
| 102 | rotor |
| 109 | gap |
| 110 | slot |
| 111 | in-phase slot |
| 112, 112A, 112B | out-of-phase slot |
| 113 | coil insertion region |
| 114 | slot opening portion |
| 120 | coil |
| 120G | phase coil |
| 121, 121a, 121b, 121c, 121d | conductor crossover portion |
| 122, 122a, 122b, 122c, 122d, 122e | conductor slot portion |
| 123 | lead-out portion |
| 123A, 123B | lead-out wire |
| 124 | corner portion |
| 125 | folded portion |
| 126 | connecting portion |
| 130 | element wire |
| 140 | insulating film |
| 150 | dead space |
| 160 | stator core |
| 161a, 161b, 161c | split core |
| 162A, 162B | core split portion |
| 170 | tooth |
| 171 | tee stop |
| 172 | overhanging portion |
| 173 | wedge |
| 180 | back yoke |
| 201 | first layer |
| 202 | second layer |
| 203 | third layer |
| 204 | fourth layer |
| 400 | split stator |
| 500 | electric wheel |
| 510 | tire |
| 520 | wheel |
| 530 | rotor frame |
| 540 | connecting member |
| 550 | bearing |
| 560 | shaft |
| 570 | electric circuit |
| 600 | railway vehicle |
| 610 | support member |
| 620 | vehicle wheel |
| 630 | axle |
| 640 | carriage |
| 701, 702 | magnetic flux |
| C | rotation axis |
| R | radial direction |
| θ | circumferential direction |
| Z | axial direction |

1. A rotary electric machine comprising:
a stator core having a plurality of slots in a circumferential direction;
a stator including at least two or more phase coils each including a conductor slot portion disposed in each of the slots, a conductor crossover portion connecting the conductor slot portion at a coil end, and a lead-out portion; and
a rotor rotatably disposed facing a slot opening portion of the stator, wherein
the phase coil is wound over a group of three or more slots arranged continuously in the circumferential direction,
the slot is either an in-phase slot including one of the phase coils therein or an out-of-phase slot including two of the phase coils having different phases,
the conductor slot portions are arranged in a line in a radial direction in the slot to form a plurality of layers, and a total number of the layers in all the slots is equal, and
(1) one out-of-phase slot is disposed on each of both sides of one in-phase slot disposed in the circumferential direction, or
(2) one out-of-phase slot is disposed on each of both sides of two or more in-phase slots continuously arranged in the circumferential direction, and
the phase coil has a substantially rectangular cross-sectional shape.

2. The rotary electric machine according to claim 1, wherein the lead-out portion includes a positive lead-out wire and a negative lead-out wire, and the phase coil is folded in the circumferential direction and wound at positions of one and another of the two out-of-phase slots disposed on both sides of the in-phase slot.

3. The rotary electric machine according to claim 2, wherein the phase coil is wound to straddle the in-phase slot and the out-of-phase slot in a state of being shifted in the radial direction by one of the layers.

4. The rotary electric machine according to claim 3, wherein the two phase coils having different phases in the out-of-phase slots are alternately disposed in the radial direction.

5. The rotary electric machine according to claim 4, wherein two or more of the in-phase slots are continuously disposed in a circumferential direction, and the phase coil is wound while maintaining the same layer in a group of the in-phase slots arranged continuously.

6. The rotary electric machine according to claim 5, wherein the total number of the layers is an even number, and the positive lead-out wires and the negative lead-out wires are led out only from one side of an axial end portion of the stator core.

7. The rotary electric machine according to claim 5, wherein the total number of the layers is an odd number, one of the positive lead-out wire and the negative lead-out wire is led out from one end side of an axial end portion of the slot, and another is led out from another end side of the axial end portion of the slot.

8. The rotary electric machine according to claim 1, wherein the stator core is divided by a back yoke portion in a circumferential direction corresponding to a position where the out-of-phase slot is placed.

9. The rotary electric machine according to claim 1, wherein a relationship of W₁ ≤ W₂ is satisfied, where W₁ is a minimum value of widths of the in-phase slot and the out-of-phase slot in the circumferential direction, and W₂ is a minimum value of a width of the slot opening portion in the circumferential direction.

10. The rotary electric machine according to claim 1, wherein the phase coil has a folded portion at a coil end of the out-of-phase slot, the phase coil folded at the coil end is wound around the in-phase slot adjacent to the out-of-phase slot, and the phase coils corresponding to the plurality of layers are integrally molded.

11. The rotary electric machine according to claim 10, wherein the folded portion protrudes in an axial direction by a length equal to or longer than a protruding length of the coil end in the axial direction.

12. The rotary electric machine according to claim 5, wherein the conductor slot portion and the conductor crossover portion are configured as an integrated coil element, and the coil elements are connected by any one of welding, soldering, fitting, plating, and crimping.

13. The rotary electric machine according to claim 1, wherein the slot is an open type slot, and the stator core includes a split core.

14. The rotary electric machine according to claim 1, wherein the slot is a semi-closed slot.

15. An electric wheel comprising the rotary electric machine according to claim 1,
wherein the rotary electric machine is directly connected to the wheel only by mechanical coupling without a gear.

16. A vehicle comprising the rotary electric machine according to claim 1,
wherein the rotary electric machine is directly connected to a vehicle wheel only by mechanical coupling without a gear.
